(19) United States
(12) Patent Application Publication
(10) Pub. No.: US 2010/0294416 A1
(43) Pub. Date: Nov. 25, 2010

(54) PROTECTIVE TAPE JOINING METHOD AND PROTECTIVE TAPE JOINING APPARATUS

(76) Inventors: Masayuki Yamamoto, Osaka (JP); Naoki Ishii, Kameyama-shi (JP)

Correspondence Address: Cheng Law Group, PLLC, 1100 17th Street, N.W., Suite 503, Washington, DC, 20036, US

(21) Appl. No.: 12/762,660

(22) Filed: Apr. 19, 2010

(30) Foreign Application Priority Data
May 22, 2009 (JP) 2009-124464

(51) Int. Cl. B32B 38/00; B32B 43/00

(52) U.S. Cl. 156/64; 156/350

(57) ABSTRACT

A tape level detecting device detects a level of a protective tape supplied above a holding table in a given position on a side where joining of the protective tape starts to control the level of the protective tape in the given position on the side where the joining starts in accordance with detected results on the level of the protective tape such that the detected level of the protective tape may fall within a reference range set in advance.

### BACKGROUND OF THE INVENTION

1. Field of the Invention

This invention relates to a method and apparatus for joining a protective tape to a surface of a semiconductor wafer having a circuit pattern formed thereon.

2. Description of the Related Art

JP 2007-227533A discloses one example of a protective tape joining apparatus configured to press a protective tape that is fed out from a tape supply section and supplied above a holding table by a joining roller to join it to a surface of a semiconductor wafer.

The above apparatus, however, has the following problem. That is, in the protective tape joining apparatus mentioned above, a joining unit and a separation unit are in a standby condition in a position of a holding table on a side where joining of the tape starts. With this condition, the semiconductor wafer placed and held by a wafer holder at an end of a robot arm is inserted between the holding table and the protective tape supplied thereabove, and is placed on the holding table via a suction-holding member that moves in and out vertically from the holding table. As illustrated in FIG. 1, however, the protective tape T supplied hangs down to be close to the holding table 5. The hanging protective tape T may cause such a trouble to contact the semiconductor wafer W to be inserted when the wafer is transported.

Moreover, the hanging protective tape T contacts the semiconductor wafer W that is placed and held on the holding table 5 before the protective tape is joined thereto, which results in some wrinkles in the protective tape T.

### SUMMARY OF THE INVENTION

This invention provides a method and apparatus for transporting a semiconductor wafer smoothly between a supplied protective tape and a holding table, thereby suppressing wrinkles to join the tape satisfactorily.

Additional features of the invention will be set forth in the description which follows, and in part will be apparent from the description, or may be learned by practice of the invention.

The present invention discloses a method of joining a protective tape to a surface of a semiconductor wafer by guiding the protective tape fed out from a tape supply section above a holding table that holds the semiconductor wafer, and pressing the protective tape with a joining member moving relative to the holding table, the method including the steps of detecting a level of the protective tape supplied above the holding table in a given position on a side where joining of the protective tape starts, and controlling the level of the protective tape in the given position on the side where the joining starts in accordance with detected results on the level of the protective tape such that the detected level of the protective tape may fall within a reference range set in advance.

According to the protective tape joining method of this invention, great hanging of the protective tape may be suppressed in the given position on the side where the joining starts. In other words, the protective tape may be set to a tape level where the tape never contacts the semiconductor wafer inadvertently when inserting the semiconductor wafer between the protective tape and the holding table.

Herein, in the above method, where the detected protective tape level is out of the reference range, it is preferable to control the protective tape level while winding up or feeding out the protective tape in a tape supply direction.

According to this method, the protective tape is transported only in the tape supply direction. Thus, rubbing of the protective tape may be suppressed that would tend to occur in case of reciprocating of a guide roller by winding back the protective tape. That is, the protective tape may be joined to the surface of the semiconductor wafer while a thickness thereof during transported is maintained. Consequently, variation in thickness of the wafer may be suppressed that may occur from variations in thickness of the protective tape in a back grinding process.

In the method mentioned above, it is also preferable to detect the level of the protective tape from when the semiconductor wafer is to be transported between the supplied protective tape and the holding table until the protective tape is joined to the semiconductor wafer, and to control the tape level in accordance with the detected results.

With this method, the tape level may be suitably maintained not only when the semiconductor wafer is transported and placed on the holding table but also from when the semiconductor wafer is transported and placed on the holding table until the tape joining is completed.

In other words, the protective tape may be joined without inadvertently contacting the semiconductor wafer before the protective tape is joined thereto.

Herein, where the tape is maintained at an appropriate level, a moderate tension is applied to the protective tape. That is, buildup of a contraction stress in the protective tape may be suppressed in an excessive tension application.

Thus, the thinned wafer having reduced rigidity after a back grinding process with the protective tape joined thereto will not bend toward the surface side thereof.

The present invention also discloses a protective tape joining apparatus for joining a protective tape to a semiconductor wafer, the apparatus including a holding table to hold the semiconductor wafer placed thereon, a tape supply unit to supply the protective tape above the holding table, a tape level detector to detect a level of the protective tape supplied above the holding table in a given position on a side where joining of the protective tape starts, a controller to control the level of the protective tape on the side where the joining starts in accordance with detected results of the protective tape level such that the detected tape level falls within a range set in advance, a transport mechanism to transport the semiconductor wafer between the protective tape with a controlled level and the holding table and to place the semiconductor wafer on the holding table, a joining unit with a joining member to press the protective tape against the semiconductor wafer placed and held on the holding table by relatively moving the joining member from one end to another end of the holding table, a tape cutting mechanism to cut the protective tape joined to the semiconductor wafer along a contour of the semiconductor wafer, a separation unit to separate an unnecessary portion of the protective tape after cutting, and a tape collecting section to wind up and collect the unnecessary portion of the protective tape after separating.

With this configuration, the tape level detector may detect the protective tape level on the side where the joining of the protective tape starts, and the controller may compare the detected results with the reference range set in advance to vary the tape level to an appropriate level. Consequently, the wafer may be transported between the protective tape and the holding table with no trouble such as contacting to the protective tape.

The tape level detector in the above apparatus may move together with the joining unit.

With this configuration, the tape level may be detected in a suitable position with no need for special adjustment or operations when the semiconductor wafer varies in size.

The tape level detector in the above apparatus may be formed of a light source and a line sensor that are arranged opposite to each other in a protective tape width direction.

With this configuration, the tape level may be detected accurately in a non-contact manner.

The tape level detector in the above apparatus may be formed of a distance sensor to determine the level of the protective tape.

With this configuration, the tape level may be detected accurately in a non-contact manner, and any detected range may be set with no need for mechanical adjustment.

The tape supply section in the above apparatus has a separation member with a proximal end thereof being swingingly supported so as to separate a separator joined to an adhesive layer of the protective tape and to feed out and guide the separated protective tape, and an elastic body to bias a tip end of the separation member upwardly. The tape level detector is formed of a sensor to detect a swing angle of the separation member at the tip end thereof that is displaced due to its own weight of the protective tape.

With this configuration, hanging of the protective tape may easily be detected based on variations in the swing angle of the separation member. Moreover, no sensor is installed on the tape joining side, which results in improved maintainability in the position where the tape is joined.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a front view of a conventional protective tape joining apparatus.

FIG. 2 is a perspective view of a protective tape joining apparatus.

FIG. 3 is a front view of the protective tape joining apparatus.

FIG. 4 is an enlarged view around a holding table as a main component of the protective tape joining apparatus.

FIGS. 5 to 10 are front views each showing a protective tape joining process.

FIG. 11 is an operation flow chart.

FIG. 12 is a front view of a protective tape joining apparatus according to another exemplary embodiment.

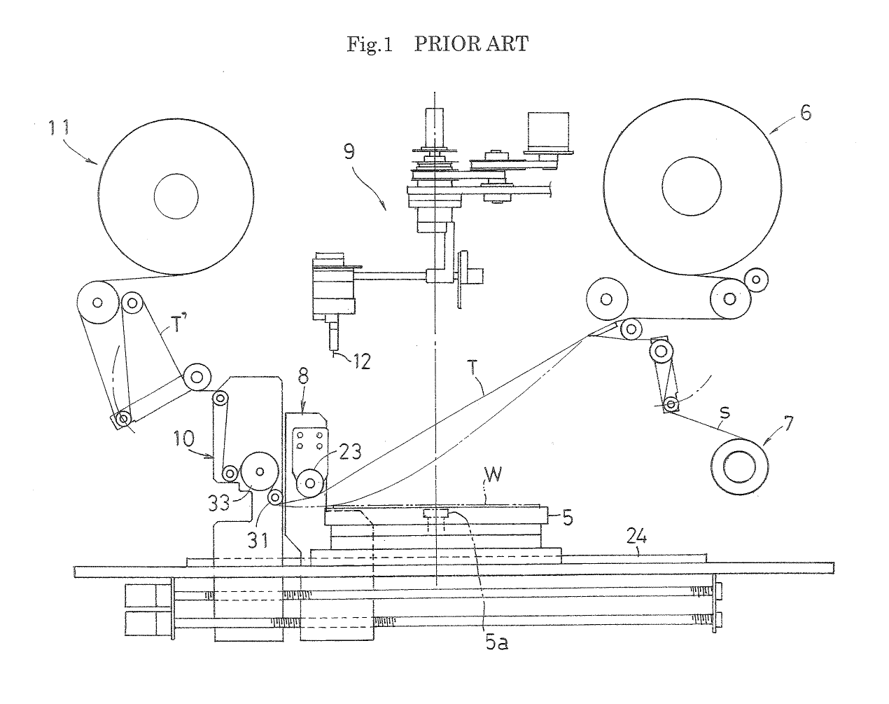

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

One exemplary embodiment of this invention will be described in detail hereinafter with reference to the drawings.

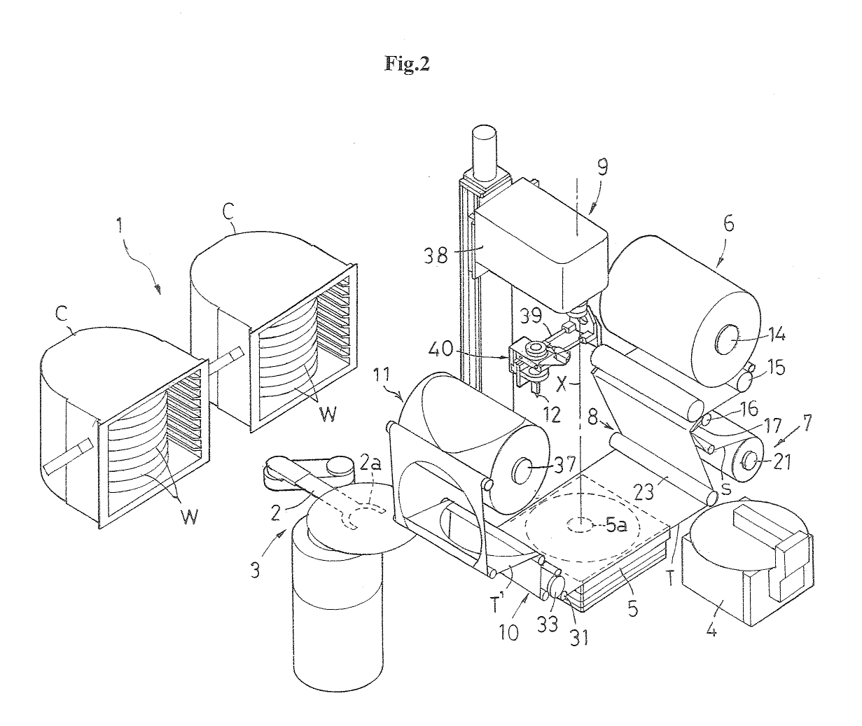

FIG. 2 is a perspective view showing a whole configuration of a protective tape joining apparatus.

This protective tape joining apparatus includes a wafer supply/collection section 1 with a cassette C mounted therein to house a semiconductor wafer (hereinafter, simply referred to as a “wafer”) W, a wafer transport mechanism 3 with a robot arm 2, an alignment stage (aligner) 4, a holding table 5 to suction-hold the wafer W placed thereon, a tape supply section 6 to supply a surface protective tape T provided with a separator s onto a position above the wafer W, a separator collecting section 7 to separate the separator s from the protective tape T supplied from the tape supply section 6 and collect the separator s, a joining unit 8 to join the protective tape T to the wafer W placed on and suction-held by the holding table 5, a tape cutting mechanism 9 to cut out the protective tape T joined to the wafer W along a contour of the wafer W, a separation unit 10 to separate an unnecessary tape T remaining after joined to the wafer W and cut out, and a tape collecting section 11 to wind up and collect the unnecessary tape T separated by the separation unit 10. Description will be made in detail hereinafter of the configurations of each component and mechanism mentioned above.

The wafer supply/collecting section 1 has two cassettes C placed therein in parallel. Many wafers W are inserted into and housed in each cassette C horizontally in a stack manner such that each circuit pattern plane thereof is directed upward.

The robot arm 2 in the wafer transport mechanism 3 may move forward and backward horizontally. Moreover, the entire robot arm 2 may pivot and move vertically. The robot arm 2 has at the tip end thereof a wafer holder 2a of a vacuum suction type formed in a horseshoe shape. The wafer holder 2a is inserted between the stacked wafers W housed in the cassette C, and suction-holds the wafer W on a rear face (undersurface) thereof. The robot arm 2 pulls out the suction-held wafer W from the cassette C, and transports the wafer W to the alignment stage 4, the holding table 5, and the wafer supply/collecting section 1, in turn. Herein, the wafer transport mechanism 3 corresponds to the transport mechanism in this invention.

The wafer transport mechanism 3 transports the wafer W to the alignment stage 4 and places the wafer W onto the alignment stage 4. The alignment stage 4 performs alignment of the wafer W based on a notch or an orientation mark formed at an outer periphery of the wafer W.

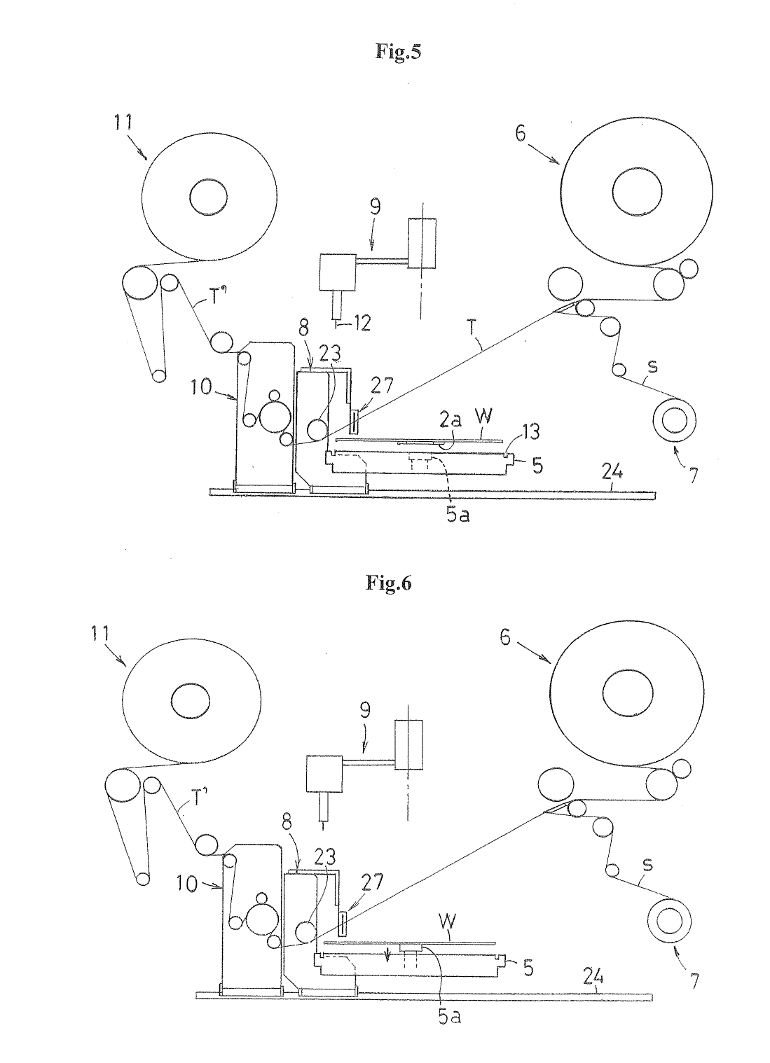

The holding table 5 sucks by vacuum the wafer W that is transported by the wafer transport mechanism 3 and placed in a predetermined alignment position. Moreover, a cutter traveling groove 13 is formed on a top face of the holding table 5 (see FIG. 5.) The cutter traveling groove 13 allows a cutter blade 12 of the tape cutting mechanism 9 (to be described later) to travel along the contour of the wafer W for cutting the protective tape T. Furthermore, a suction holder 5a is provided at a center of the holding table 5 that moves in and out vertically when the wafer is transported.

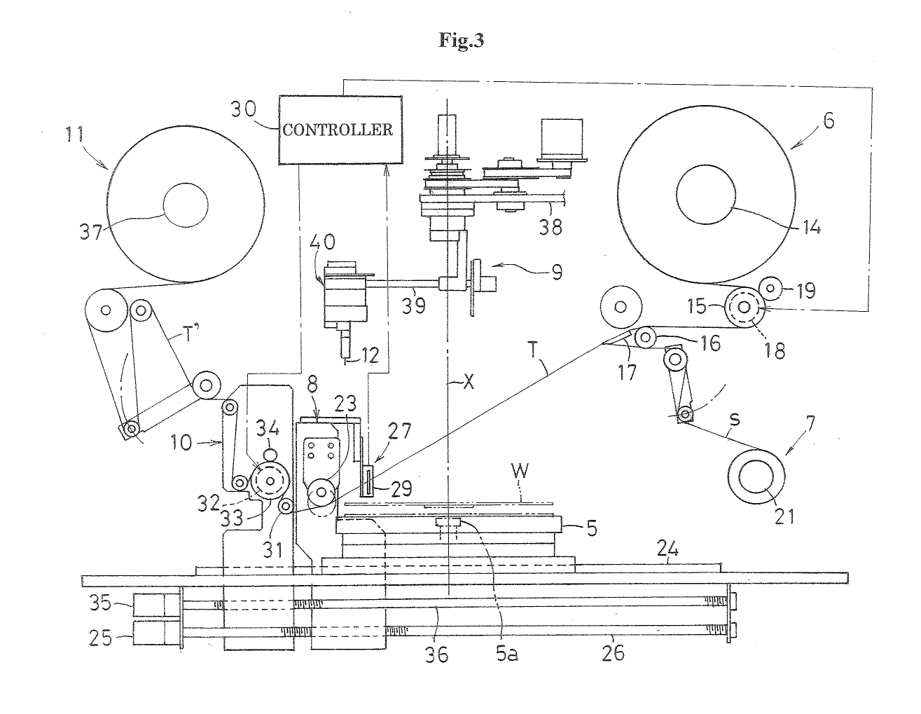

The tape supply section 6 has the following configurations. That is, the tape supply section 6 winds up the protective tape T provided with the separator s fed out from a supply bobbin 14 and guides the protective tape T with a feed roller 15 and a guide roller 16 to a separation guide bar 17. The separation guide bar 17 separates the separator s from the protective tape T at the tip edge thereof by folding back the protective tape T, and the protective tape T with the separator s separated therefrom is guided to the joining unit 8. As illustrated in FIG. 3, the feed roller 15 guides the protective tape T with a pinch roller 19, and rotates with the motor 18. The feed roller 15 forcibly feeds out the protective tape T as required.

The separator collecting section 7 has a collecting bobbin 21 to wind up the separator s separated from the protective tape T. The collecting bobbin 21 rotates to wind up the separator s at appropriate times.

The joining unit 8 has a joining roller 23 capable of moving upward and downward by a cylinder (not illustrated.) The joining unit is entirely supported so as to move horizontally along a guide rail 24. That is, the joining unit 8 reciprocates in a screw feed manner via a screw shaft 26 capable of rotating reversibly by the motor 25. Herein, the joining roller 23 corresponds to the joining member in this invention.

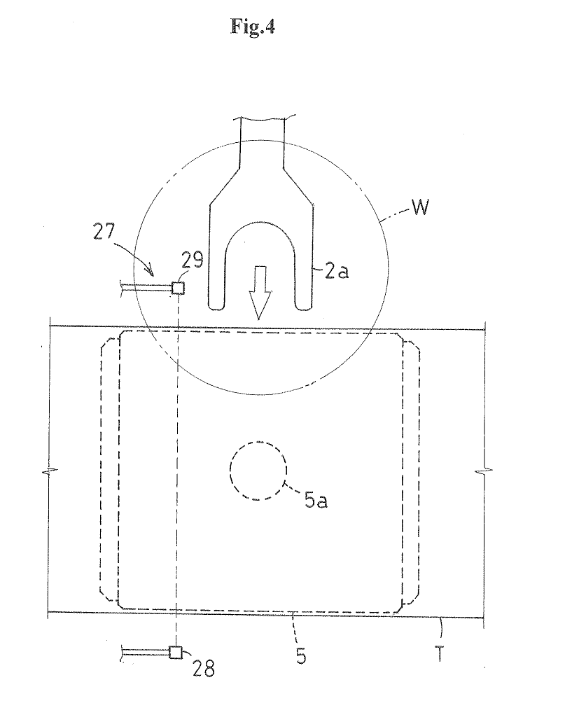

The joining unit 8 is integrally provided with a tape level detection mechanism 27 to detect a level of the supplied protective tape T. As illustrated in FIGS. 4 and 5, the tape level detection mechanism 27 has a light source 28 arranged opposite to each other in a width direction of the protective tape T and a line sensor 29 with a predetermined length in a longitudinal direction that is vertically mounted. That is, the intersecting position of the protective tape T and the line sensor 29 may be detected based on intensity variations between the light from the light source and that received with the line sensor 29, and the detected results are transmitted to a control device 30. The tape level detection mechanism 27 corresponds to the tape level detector in the present invention, and the control device 30 to the controller, respectively.

Referring now to FIG. 3, the separation unit 10 includes a separation roller, a feed roller 33 driven by a motor 32, and a pinch roller 34 to nip the tape. The separation unit is entirely supported so as to move horizontally along the guide rail 24. That is, the separation unit 10 reciprocates in a screw feed manner via a screw shaft 36 capable of rotating reversibly by the motor 35.

The tape collecting section 11 includes a collection bobbin 37 driven by a motor. The collection bobbin 37 rotates in a direction to wind up an unnecessary tape T.

The tape cutting mechanism 9 has a support arm 39 below a movable table 38 capable of moving vertically, so as to turn about a longitudinal axis X on the center of the holding table 5. The support arm 39 has a cutter unit 40 at a free end thereof, and the cutter unit 40 includes the cutter blade 12 having a cutting edge directed downward. That is, when the support arm 39 turns about the longitudinal axis, the cutter blade 12 travels along an outer periphery of the wafer W. The tape cutting mechanism 9 is configured so as to cut the protective tape T along the contour of the wafer.

Next, with reference to FIGS. 5 to 10, description will be made of a series of basic operations for joining the protective tape T to the surface of the wafer W using the above-mentioned apparatus according to one exemplary embodiment of this invention.

A joining command is issued, and then the robot arm 2 in the wafer transport mechanism 3 moves towards the cassette C placed on a cassette table. The wafer holder 2a is inserted between the wafers W housed in the cassette C. The wafer holder 2a suction-holds the wafer W on the rear face (the underside) thereof, and pulls out the wafer W, and moves to place the wafer W on the alignment stage 4.

The alignment stage 4 performs alignment of the wafer W placed thereon, through use of the notch or orientation mark formed at the outer periphery of the wafer W. The robot arm 2 then transports the aligned wafer W from the alignment stage 4 above the holding table 5. As illustrated in FIG. 5, herein, the joining unit 8 and separation unit 10 are in a standby position. Moreover, the cutter blade 12 of the tape cutting mechanism 9 is in a standby position.

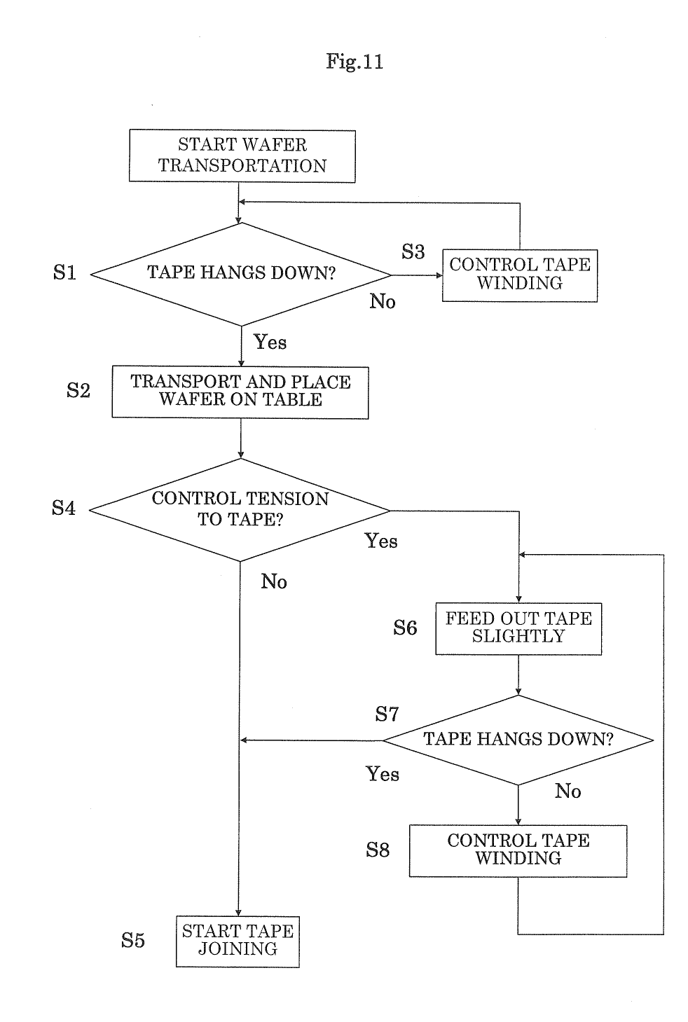

As illustrated in the flow chart of FIG. 11, when transportation of the wafer W starts, control is performed so as to eliminate hanging of the protective tape T.

Specifically, upon starting transportation of the wafer W, the tape level detecting mechanism 27 detects the tape level in a given position on a side where a joining process starts, and the detected signal is transmitted to the control device 30. The reference range stored in a memory in advance includes an upper limit and a lower limit, and a computing processor provided in the control device 30 compares the tape level with the lower limit. Where the level of the protective tape T is lower than the lower limit set in advance through comparison, the protective tape T is determined to hang down below the reference level (STEP S01.)

When it is determined that the tape level falls within the reference range set in advance and the protective tape T is determined not to hang down, the wafer W is inserted between the supplied protective tape T and the holding table 5 with no interference such as contacting to the protective tape T, as illustrated in FIG. 5. Next, as illustrated in FIG. 6, the suction holder 5a moves upward at the center of the holding table 5 to suction-hold the rear face of the wafer W, and the wafer holder 2a of the robot arm 2 releases suction holding and retracts. Subsequently, the suction holder 5a moves downward so as to be accommodated in the holding table 5. The wafer W is then placed on the holding table 5 to complete transporting and setting of the wafer W (STEP S02.)

When the control device 30 determines that the tape level is lower than the lower limit set in advance and therefore the protective tape T hangs down, the pinch roller 19 holds the protective tape T on the feed roller 15 while the motor 18 stops. With this condition, the feed roller 33 drives to feed the protective tape T in the tape supply direction. Specifically, control is performed of winding up the protective tape T while applying a moderate tension to the protective tape T until the tape level falls within the reference range set in advance (STEP S03.)

When the transporting and setting of the wafer W is completed, it is determined whether or not to perform control of applying a tension to the protective tape T (STEP S04). Where a performance command is not inputted and set in the control device 30, the process immediately proceeds to a tape joining process to join the protective tape T (STEP S05), as will be described hereafter.

Where the performance command is inputted and set in advance, the feed roller 15 drives to feed the protective tape T by a predetermined length, leading to slack in the protective tape T (STEP S06.)

After provision of the slack, the tape level detecting mechanism 27 detects the tape level. The control device 30 determines, based on the detected results, whether or not the level of the protective tape T is largely out of the given reference range and the protective tape T greatly hangs down due to the slack (STEP S07.)

When it is determined that a moderate tension is applied to the protective tape T without greatly handing down, the process proceeds to a tape joining process (STEP S05.)

Where the control device 30 determines that the level of the protective tape T is largely out of the given reference range and the protective tape T greatly hangs down due to the slack, only the feed roller 33 drives to temporarily control winding up of the protective tape T (STEP S08.) Subsequently, the protective tape T is slightly fed out (STEP S06) to provide the slack therein so as to determine whether or not the protective tape T hangs down (STEP S07.) The processes from STEP S06 to STEP S08 are repeated to apply a moderate tension to the protective tape T.

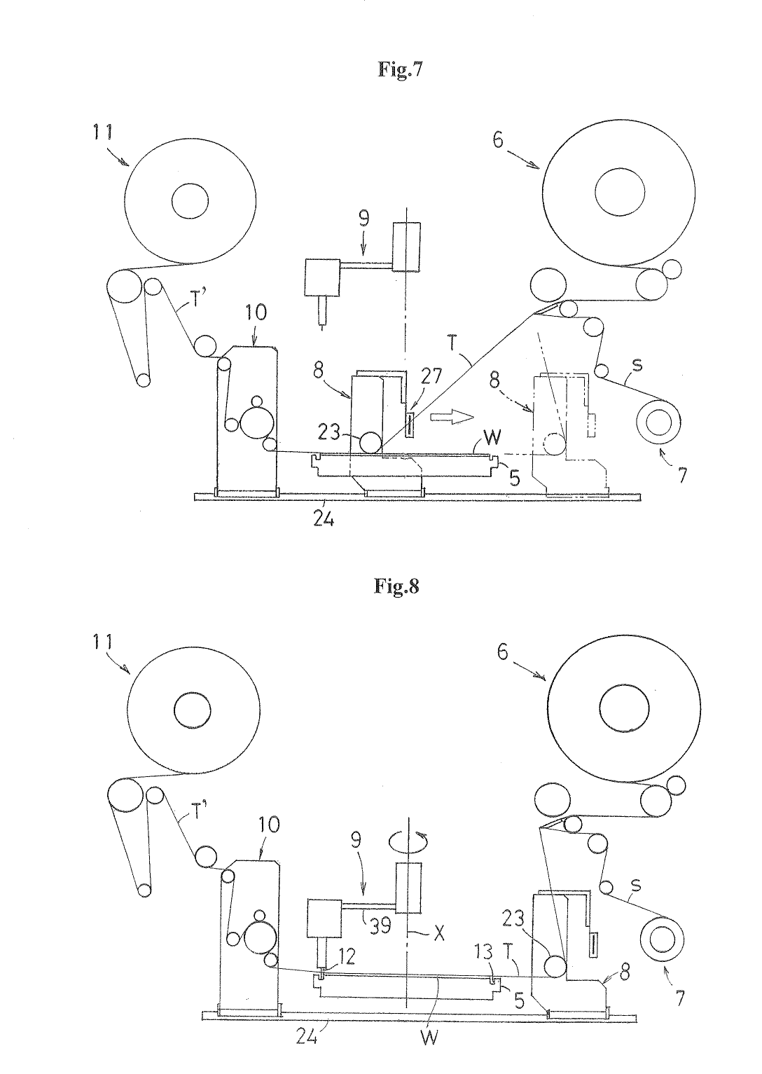

After proceeding to the tape joining process, the joining roller 23 moves downward, and presses the protective tape T against the wafer W while rolling on the wafer W by forward movement of the joining unit 8 (in the right direction in plane of FIG. 7), as illustrated in FIG. 7. With this movement, the protective tape T may be joined to the surface of the wafer W from the left in plane of FIG. 7.

As illustrated in FIG. 8, when the joining unit 8 reaches a joining termination position over the holding table 5, the cutter blade 12 on the upper side moves downward, and pierces the protective-tape T at the cutter blade traveling groove 13 of the holding table 5.

Next, a holding arm 39 turns in a given direction, and thus the cutter blade 12 turns about the longitudinal axis X, thereby cutting the protective tape T along the contour of the wafer W.

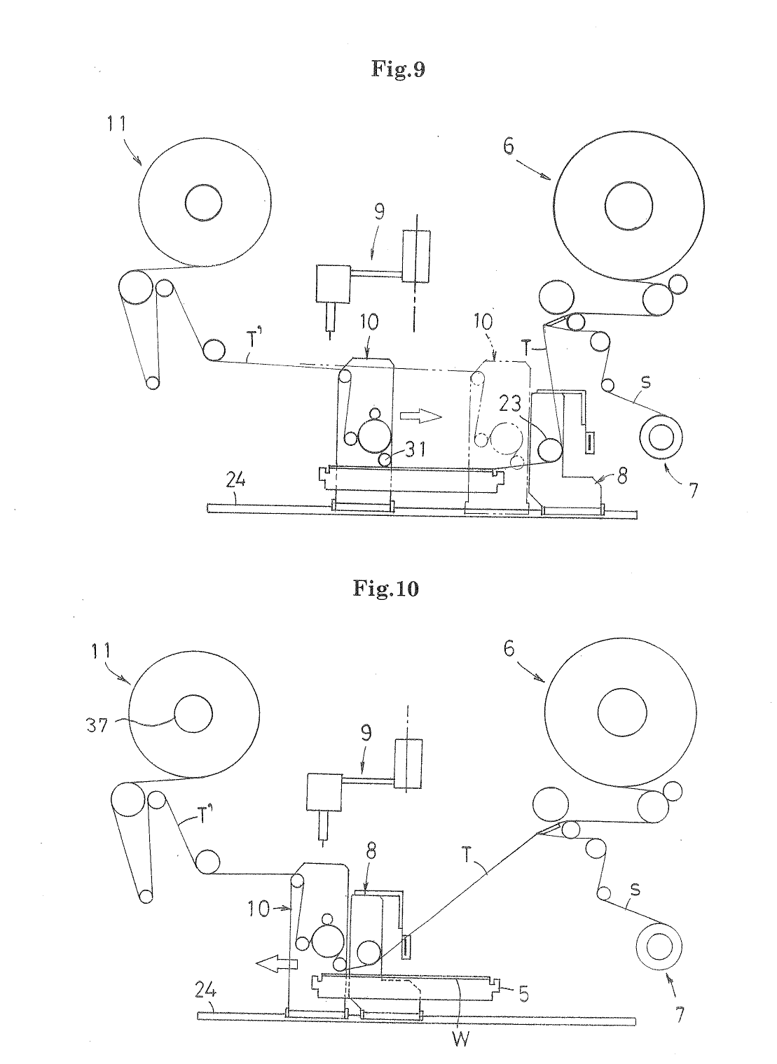

When cutting of the protective tape T along the contour of the wafer W is completed, the cutter blade 12 moves upward to the original standby position, as illustrated in FIG. 9. The separating unit 10 then moves forward while winding up and separating the unnecessary tape T′ remaining after cutting out on the wafer W.

When the separating unit 10 reaches a position where separating is completed, the separation unit 10 and joining unit 8 move backward (to the left in plane of FIG. 10) and return to the original standby position, as illustrated in FIG. 10. Here, the collecting bobbin 37 winds up the unnecessary tape T, and the tape supply section 6 feeds out a given length of the protective tape T.

When the above tape joining operation is completed, the holding table 5 releases the suction holding of the wafer W. Subsequently, the suction holder 5a transports the wafer W subjected to the joining process above the holding table 5. With this condition, the suction holder 5a places the wafer W on the wafer holder 2a of the robot arm 2 and inserts it into the cassette C in the wafer supply/collection section 1.

Thus, one protective tape joining process is completed as described above. Thereafter, the foregoing operations are to be repeated on each new wafer in succession.

With the apparatus according to the above embodiment, the protective tape T may be prevented from greatly handing down that would tend to occur in joining. Consequently, a space may be obtained between the protective tape T and the holding table 5 where the wafer is to be transported, thereby suppressing inadvertent contact of the protective tape T to the wafer W before joining the protective tape thereto.

Moreover, with the apparatus according to the above embodiment, the protective tape T is transported only in the tape supply direction. That is, suppression of the rubbing may prevent the protective tape T from extending, and thus the protective tape may be joined to the surface of the semiconductor wafer with a constant thickness at the time of feeding out the protective tape T. Consequently, variation in thickness of the wafer may be suppressed that may occur from variations in thickness of the protective tape T in a back grinding process.

This invention is not limited to the foregoing embodiment, but may be modified as follows.

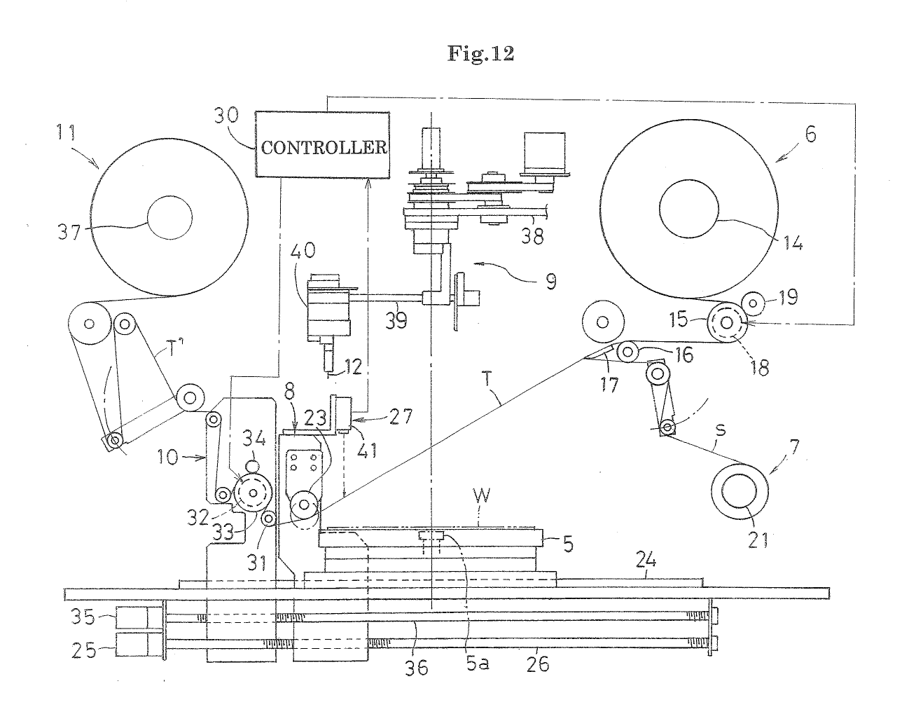

As illustrated in FIG. 12, an ultrasonic or infrared distance measurement sensor 41 may detect the level of the protective tape T as the tape level detection mechanism 27. Specifically, the distance measurement sensor 41 placed above the protective tape T determines a distance to the protective tape T. The reference level is read out to the computing processor that is stored in advance in the storage such as a memory in the control device for comparison with the measured results. It is determined whether or not an actual measurement falls within a range from the lower limit to the upper limit of the reference level over the results of the computing process, leading to determination whether or not the protective tape T hangs down. Where it is determined that the protective tape T hangs down, only the feed roller 33 drives to control winding up of the protective tape T so as to apply a moderate tension to the protective tape T, as is the case with the above embodiment. Here, the distance measurement sensor 41 corresponds to the distance sensor in this invention.

The tape level detecting mechanism 27 may be adopted so as to determine an angle of the supplied protective tape T appropriately and compute the tape level in a given position based on the determined angle.

For instance, let a setting angle of the separation guide bar 17 be a reference angle when a given level of the protective tape T is maintained in the position where the joining of the protective tape T starts. When its own weight of the protective tape T due to slack thereof is applied to the separation guide bar 17, biasing force of the elastic body such as a spring to lift up the tip end of the separation guide bar 17 becomes lower than the own weight of the protective tape T. Consequently, the separation guide bar 17 swingingly moves downward. With such a configuration, a rotation angle of the separation guide bar 17 is determined with the sensor such as an encoder provided on a rotation axis of the separation guide bar 17, and the determined result is transmitted to the control device 30.

The control device 30 determines a hanging condition of the protective tape using correlation data set in advance on requirements to transport the wafer W on the holding table 5 in relation with the hanging condition of the protective tape T as well as the rotation angle of the separation guide bar 17.

Where it is determined that the protective tape T hangs down, the control device 30 drives only the feed roller 33 so as to apply a moderate tension to the protective tape T, as is the case with the above embodiment. The protective tape T is controlled such that the separation guide bar 17 returns to the reference angle thereof while a load is reduced that is applied to the separation guide bar 17 due to the own weight of the protective tape T. Here, the separation guide bar 17 corresponds to the separation member in this invention.

In the exemplary embodiment described above, the control device 30 determines in STEP S01 whether the protective tape T hangs down. The control device 30 may also be configured so as to determine whether an excessive tension is applied to the protective tape T when the tape level exceeds the upper limit of the reference level. In this case, the line sensor 29 detects the level of the protective tape T at a given level different from the reference level. Specifically, where the tape level is detected more than the reference level, the feed roller 15 on the side of the tape supply section 6 only drives so as to control the feed length of the protective tape T.

In the exemplary embodiment mentioned above, the line sensor may detect the level of the protective tape T in real time to control the feed length of the protective tape T based on the detected results during the process of joining the protective tape T.

With this configuration, a back tension may be maintained constant that acts on the protective tape T in joining Consequently, buildup of a contraction stress in the protective tape may be suppressed in an excessive tension application, and thus the thinned wafer with reduced rigidity after a back grinding may be avoided from bending.

In the exemplary embodiment mentioned above, the tape level detection mechanism 27 may be fixed relative to the holding table 5.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of joining a protective tape to a surface of a semiconductor wafer by guiding the protective tape fed out from a tape supply section above a holding table that holds the semiconductor wafer and pressing the protective tape with a joining member moving relative to the holding table, the method comprising the steps of:
detecting a level of the protective tape supplied above the holding table in a given position on a side where joining of the protective tape starts, and
controlling the level of the protective tape in the given position on the side where the joining starts in accordance with detected results on the level of the protective tape such that the detected level of the protective tape falls within a reference range set in advance.

2. The method of joining the protective tape according to claim 1, wherein
where the detected protective tape level is out of the reference range, the level of the protective tape is controlled while the protective tape is wounded up or fed out in a tape supply direction.

3. The method of joining the protective tape according to claim 1, wherein
the level of the protective tape is detected from when the semiconductor wafer is to be transported between the supplied protective tape and the holding table until the protective tape is joined to the semiconductor wafer, and is controlled in accordance with the detected results.

4. The method of joining the protective tape according to claim 1, wherein
a line sensor receives light from a light source arranged across the protective tape in a protective tape width direction, and determines the level of the protective tape based on intensity variations of the light in receiving.

5. The method of joining the protective tape according to claim 1, wherein
a distance measurement sensor placed above the protective tape determines the level of the protective tape.

6. The method of joining the protective tape according to claim 1, wherein
an elastic body biases a separation guide bar upwardly to separate the separator joined to the protective tape;
a swing angle of the separation guide bar is detected when the protective tape is supplied;
the detected actual angle is compared with a reference angle set in advance; and
the level of the protective tape is detected using correlation data set in advance in relation with hanging condition of the protective tape as well as a rotation angle of the separation guide bar.

7. A protective tape joining apparatus for joining a protective tape to a semiconductor wafer, the apparatus comprising:
a holding table to hold the semiconductor wafer placed thereon;
a tape supply unit to supply the protective tape above the holding table;
a tape level detector to detect a level of the protective tape supplied above the holding table in a given position on a side where joining of the protective tape starts;
a controller to control the level of the protective tape on the side where the joining starts in accordance with detected results of the protective tape level such that the detected tape level falls within a range set in advance;
a transport mechanism to transport the semiconductor wafer between the protective tape with a controlled level and the holding table, and to place the semiconductor wafer on the holding table;
a joining unit with a joining member to press the protective tape against the semiconductor wafer placed and held on the holding table by relatively moving the joining member from one end to another end of the holding table;
a tape cutting mechanism to cut the protective tape joined to the semiconductor wafer along a contour of the semiconductor wafer;
a separation unit to separate an unnecessary portion of the protective tape after cutting; and
a tape collecting section to wind up and collect the unnecessary portion of the protective tape after separating.

8. The apparatus for joining the protective tape according to claim 7, wherein
the tape level detector moves together with the joining unit.

9. The apparatus for joining the protective tape according to claim 7, wherein
the tape level detector is formed of a light source and a line sensor that are arranged opposite to each other in a protective tape width direction.

10. The apparatus for joining the protective tape according to claim 7, wherein
the tape level detector is formed of a distance sensor to determine the level of the protective tape.

11. The apparatus for joining the protective tape according to claim 7, wherein
the tape supply section comprises a separation member with a proximal end thereof being swingingly supported so as to separate a separator joined to an adhesive layer of the protective tape and to feed out and guide the separated protective tape, and an elastic body to bias a tip end of the separation member upwardly, the tape level detector being formed of a sensor to detect a swing angle of the separation member at the tip end thereof that is displaced due to its own weight of the protective tape.
